(19) United States
(12) Patent Application Publication
(10) Pub. No.: US 2017/0203633 A1
(43) Pub. Date: Jul. 20, 2017

(54) APPARATUS AND METHOD FOR REFRIGERATION UNIT CONTROL

(71) Applicant: Wal-Mart Stores, Inc., Bentonville, AR (US)

(72) Inventors: Donald R. High, Noel, MO (US); Anton Valkov, San Francisco, CA (US); Todd D. Mattingly, Bentonville, AR (US)

(21) Appl. No.: 15/411,111

(22) Filed: Jan. 20, 2017

Related U.S. Application Data
(60) Provisional application No. 62/280,975, filed on Jan. 20, 2016.

(51) Int. Cl. B60H 1/00; B60H 1/32

(52) U.S. Cl. CPC B60H 1/00735; B60H 1/32; B60H 2001/3255; B60H 1/3232; B60H 1/3205; B60P 3/007

(57) ABSTRACT

Systems, apparatuses and methods are provided herein for refrigeration unit control. A system for refrigeration unit control comprising: a refrigeration unit of a delivery vehicle configured to hold items for delivery, and a control circuit communicatively coupled to the refrigeration unit and configured to: receive an expected load time from a delivery management system, determine a current temperature, determine an estimated cooling duration for bringing a temperature inside the refrigeration unit to a target temperature based on at least the current temperature, calculate a start time for the refrigeration unit based on the estimated cooling duration and the expected load time, and cause the refrigeration unit to begin cooling at the start time.

### CROSS-REFERENCE TO RELATED APPLICATION

This application claims the benefit of U.S. Provisional Application No. 62/280,975, filed Jan. 20, 2016, which is incorporated herein by reference in its entirety.

### TECHNICAL FIELD

This invention relates generally to delivery vehicles.

### BACKGROUND

Some goods, such as dairy and frozen foods, are required to be refrigerated throughout a distribution chain. As such, some trucks are equipped with a refrigeration unit for keeping goods at a controlled temperature during transport.

### BRIEF DESCRIPTION OF THE DRAWINGS

Disclosed herein are embodiments of apparatuses and methods for providing refrigeration unit control. This description includes drawings, wherein:

FIG. 1 is a block diagram of a system in accordance with several embodiments.

FIG. 2 is a flow diagram of a method in accordance with several embodiments.

FIG. 3 is an illustration of a system in accordance with several embodiments.

Elements in the figures are illustrated for simplicity and clarity and have not necessarily been drawn to scale. For example, the dimensions and/or relative positioning of some of the elements in the figures may be exaggerated relative to other elements to help improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for refrigeration unit control. A system for refrigeration unit control comprises: a refrigeration unit of a delivery vehicle configured to hold items for delivery, and a control circuit communicatively coupled to the refrigeration unit and configured to: receive an expected load time from a delivery management system, determine a current temperature, determine an estimated cooling duration for bringing a temperature inside the refrigeration unit to a target temperature based on at least the current temperature, calculate a start time for the refrigeration unit based on the estimated cooling duration and the expected load time, and cause the refrigeration unit to begin cooling at the start time.

In some embodiments of the system described herein, trucks that are docked in range of store's or a distribution center's Wi-Fi system may automatically connect with a central computer system via an Internet of Things (IOT) system. The truck may communicate a truck ID number and its schedule to the central computer system. In some embodiments, scheduling may be automatically carried out by the central computer system. When a truck is scheduled to leave for a delivery, the central computer may start and cool down the refrigeration unit of the truck at a determined time before the scheduled departure time. The system may ensure the driver will be able to leave at his/her scheduled time and will not be required to spend time on the clock to wait for the truck to be cooled to a desired temperature. Once the truck is close to being cool enough to depart, the driver may receive an automated message with an estimated time of when the truck will be ready to depart. If drivers do not show up within the department time frame, the Internet of Things system may shut down the vehicle automatically. In some embodiments, a driver may override IOT control of the refrigeration unit if he/she activates the seat pressure sensor and/or the seat belt connectivity sensor of the vehicles. In some embodiments, the vehicles may prevent the IOT from shutting down the refrigeration unit if the driver is near the vehicle but may require more time to perform vehicle inspection and preparation (e.g. making sure truck is fueled, tires are good, all products are loaded, etc.)

Generally, a central system described herein may be configured to auto start the delivery equipment based on a delivery schedule. In some embodiments, the central system may also track an idle time of the equipment, and may shut off the equipment if it has been idle for too long. The system may allow a driver to turn on or shut off the equipment and bypassing the IOT system by connecting directly to the central computer and/or the vehicle's onboard system. In some embodiments, the central computer system may further post alerts to driver/management with updates on auto start, shut down, and departure times.

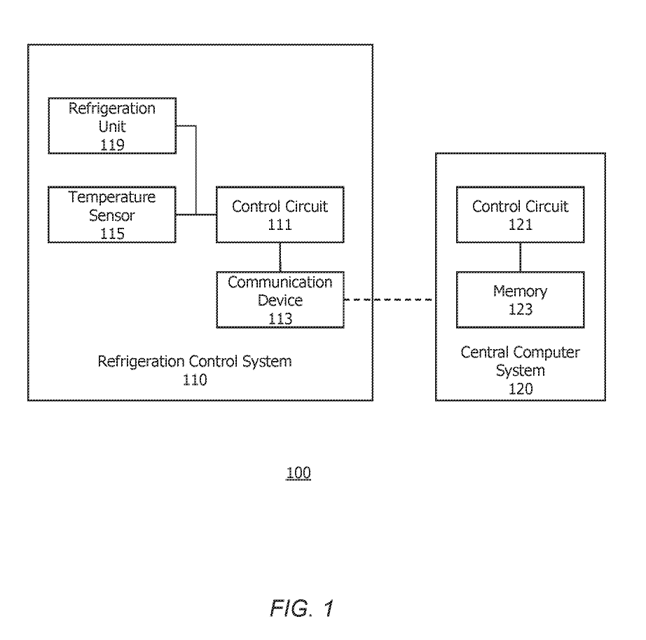

Referring now to FIG. 1, a system for providing refrigeration unit control is shown. The system 100 includes a central computer system 120 and a refrigeration control system 110. The central computer system 120 comprises a control circuit 121 and a memory 123. The refrigeration control system 110 comprises a control circuit 111, a refrigeration unit 119, a temperature sensor 115, and a communication device 113 configured to communicate with the central computer system 120.

In some embodiments, the refrigeration control system 110 may comprise a system onboard a delivery vehicle such as a truck, a van, a car, a motorcycle, a bike, a boat, a ship, and the like. Generally, the delivery vehicle may be any manned or unmanned vehicle powered to carry cargo in transit. In some embodiments, the vehicle may comprise a refrigerated delivery truck or a refrigerated delivery van. In some embodiments, the refrigeration control system 110 may be a standalone unit placed on the vehicle. In some embodiments, the refrigeration control system 110 may be at least partially integrated with the vehicle's control and/or telematics system. For example, the refrigeration delivery vehicle may share one or more of the control circuit 111 and the communication device 113 with the control and/or telematics system of the vehicle. In some embodiments, the control circuit 11 may receive user/driver input via the vehicle's control and/or telematics system. In some embodiments, the refrigeration control system 110 may be retrofitted onto conventional refrigerated delivery vehicles. Generally, refrigeration control system 110 may be configured to cause the refrigeration unit 119 to start and stop cooling based on communications with the central computer system 120.

The control circuit 111 of the refrigeration control system 110 may comprise a central processing unit, a processor, a microprocessor, and the like. The control circuit 111 may be configured to execute computer readable instructions stored on a computer readable storage memory (not shown). The computer readable storage memory may comprise volatile and/or non-volatile memory and have stored upon it a set of computer readable instructions which, when executed by the control circuit 111, causes the system to communicatively couple with the central computer system 120 and control the operation of the refrigeration unit 119 based on the communication with the central computer system 120.

The communication device 113 may comprise a short range radio frequency transceiver (e.g. Bluetooth, Wi-Fi) and/or a long range transceiver (e.g. mobile data network transceiver). In some embodiments, the communication device 113 may be configured to detect for a network associated with the central computer system 120 and/or the internet to communicate with the central computer system 120. In some embodiments, the communication device 113 may be configured to only communicate with the central computer system 120 when a recognized wireless network (e.g. distribution center Wi-Fi network, store network work, etc.) is detected. In some embodiments, the communication device 113 may be configured to maintain communication with the central computer system 120 via a long range wireless network, such as a mobile data network, during preparation, travel, delivery, and/or return.

The refrigeration unit 119 may be any device configured to actively affect the temperature of a storage area. In some embodiments, the refrigeration unit 119 may comprise one or more of a refrigerator and a freezer. In some embodiments, the refrigeration unit 119 may comprise a conventional refrigeration unit and the control circuit 111 may be configured to selectively turn the refrigeration unit on and off to start and stop cooling. In some embodiments, the refrigeration unit 119 may comprise a temperature setting and may automatically suspend cooling when the set temperature is reached and may resume cooling when the temperature of the storage area rises above a threshold temperature. In some embodiments, a refrigeration control system 110 and/or a delivery vehicle may include multiple refrigeration units. In some embodiments, the cooling of each refrigeration unit may independently start and stop.

The temperature sensor 115 may comprise a sensor configured to measure a temperature inside a storage area that is temperature controlled by the refrigeration unit 119 and/or an outside ambient temperature. In some embodiments, the temperature sensor 115 may comprise a temperature sensor built into the refrigeration unit 119. While FIG. 1 shows the temperature sensor 115 to be coupled to the control circuit 111, in some embodiments, the temperature sensor 115 may comprise a standalone wireless device configured to communicate with the control circuit 111 of the refrigeration control system 110 and/or the central computer system 120.

In some embodiments, the refrigeration control system 110 may further include and/or communicate with a driver presence sensor. The driver presence sensor may comprise one or more of a seat pressure sensor, a seat belt connectivity sensor, and a wireless transceiver for detecting user devices in close proximity of the delivery vehicle. The driver presence sensor may be used by the refrigeration control system 110 and/or the central computer system 120 to detect that a driver has arrived at the delivery vehicle and control the cooling of the refrigeration unit 119 accordingly. For example, in some embodiments, when the driver arrives at the vehicle, the system may allow the driver to manually control the refrigeration unit and override system determined schedules.

The central computer system 120 may generally comprise any processor-based device. In some embodiments, the central computer system 120 may be one or more of a computer device, a server, a cloud-based server, and the like. The central computer system 120 includes a control circuit 121 and a memory 123. The control circuit 121 may comprise a central processing unit, a processor, a microprocessor, and the like. The control circuit 121 may be configured to execute computer readable instructions stored on a computer readable storage memory 123. The computer readable storage memory 123 may comprise volatile and/or non-volatile memory and have stored upon it a set of computer readable instructions which, when executed by the control circuit 121, causes the system to selectively control the refrigeration unit based on a delivery schedule and the reading of the temperature sensor 115. In some embodiments, the memory 123 and/or a delivery management database may store schedules for multiple delivery vehicles. In some embodiments, the memory 123 and/or the delivery management database may further store additional information for delivery management such as the driver assigned to each vehicle and/or delivery trip, items expected to be loaded on to each vehicles, current statuses of each delivery vehicle, planned routes of each delivery trip, delivery address(s) for each delivery trip, etc.

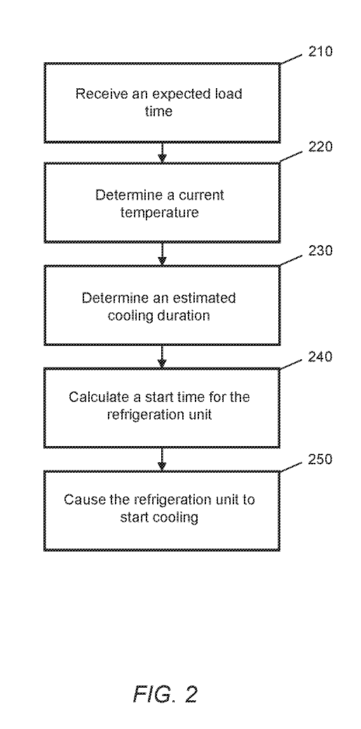

Referring now to FIG. 2, a method for refrigeration unit control is shown. Generally, the method shown in FIG. 2 may be implemented with one or more processor based devices such as devices having a control circuit, a central processor, a microprocessor, and the like. In some embodiments, each step in the method shown in FIG. 2 may be implemented with one of more of the control circuit 111 of the central computer system 120 and the control circuit 111 of the refrigeration control system 110 in FIG. 1.

In step 210, the system receives an expected load time from a delivery management system. The delivery management system may generally be a system that assigns items that need to delivered to vehicles and drivers and determine a schedule for each vehicle and driver. In some embodiments, the expected load time may be retrieved from a schedule stored in a delivery management database. In some embodiments, the expected load time may generally correspond to the time that items are scheduled to be loaded into a refrigerated storage area of a delivery vehicle. Generally, an item may be loaded from a warehouse, a distribution center, a store, another delivery vehicles, etc. In some embodiments, the load time may be a set time (e.g. 10 minutes, 20 minutes, etc.) prior to the scheduled departure time and the load time may be derived from the scheduled departure time. In some embodiments, when a delivery vehicle cannot complete a delivery due to vehicle issues, traffic accidents, etc., the delivery management system may send a substitute delivery vehicle to complete the delivery. In such cases, the expected load time may correspond to the time that the substitute delivery vehicle is expected to arrive at the location of the originally assigned delivery vehicle to transfer the items from the original vehicle to the substitute vehicle.

In step 220, the system determines a current temperature. In some embodiments, the current temperature may be measured by the temperature sensor 115 described with reference to FIG. 1. In some embodiments, the current temperature may correspond to the interior temperature of a storage area on the delivery vehicles. In some embodiments, the current temperature may correspond to the current environmental temperature at the vehicles' location. In some embodiments, the environmental temperature may be measured by a sensor outside of the delivery vehicles and/or may be retrieved from a weather reporting service.

In step 230, the system determines an estimated cooling duration for the storage area based on the current temperature determined in step 220. In some embodiment, a refrigeration unit may have associated with it, a target temperature at which items needing refrigeration could be loaded into the storage area. In some embodiments, the target temperature for loading may be equal to, higher, or lower than the transport temperature that the refrigeration unit is configured to maintain during transport. For example, the target temperature may correspond to a slightly higher temperature which is acceptable for the items to be exposed to for a short duration prior to the transport temperature is reached in the storage area. The cooling duration generally refers to the time it takes to bring the refrigeration unit's internal temperature down to the target temperature. Generally, the required cooling duration may be longer if the current temperature is further away from the target temperature. In some embodiments, the cooling duration may be determined based on a cooling model which corresponds sets of conditions to cooling durations. In some embodiments, the cooling model may correspond cooling durations to different temperature values (e.g. 75 degrees corresponds to 35 minutes of cooling duration for a freezer) and/or temperature differentials between the measured and target temperatures (a 20 degree temperature gap corresponds to 20 minutes of cooling duration, etc.). In embodiments, the cooling model may further be based on conditions relating to one or more of: a temperature inside the refrigeration unit, an environmental temperature, a humidity level, a refrigeration unit type, a refrigeration unit size, a refrigeration unit age, a vehicle type, and a previous idle time. In some embodiments, these conditions may cause set value and/or percentage increase and/or decrease of the cooling duration. For example, for large refrigeration units, minutes may be added to the cooling duration. In some embodiments, the cooling models may be at least partially based on measurements of the actual time it took to bring refrigeration units to target temperatures. In some embodiments, a cooling duration may be determined based on using one or more of the conditions above as parameters in the cooling model to determine the required duration for bringing the refrigeration unit to the target temperature.

In step 240, the system calculates a start time for the refrigeration unit. In some embodiments, the start time may be calculated based on the expected load time received in step 210 and/or a scheduled departure time and the estimated cooling duration in step 230. For example, the start time may be calculated by subtracting the estimated cooling duration from the expected load time or scheduled departure time. In some embodiments, a buffer time (e.g. 2 minutes, 5 minutes) may be added ensure that the target temperature is reached shortly before items are loaded into the refrigeration unit. In some embodiments, the start time may be calculated such that the target temperature is reached shortly after items are loaded and/or shortly after the departure time. In some embodiments, after a start time is determined and prior to the start time occurring, the system may repeat steps 220-240 periodically in case the estimated cooling duration increases or decreases due to temperature changes, and the start time may be updated accordingly.

In step 250, the system causes the refrigeration unit to start cooling based on the start time determined at step 240. In some embodiments, the system may turn on the refrigeration unit to begin the cooling of the storage area. In some embodiments, once a refrigeration unit reaches the target temperature and/or a transport temperature, the unit may suspend cooling until the temperature rises above a threshold over the target temperature and/or a transport temperature. In some embodiments, once the refrigeration unit is turned on, the enteral control system of the refrigeration unit may determine when to suspend and resume cooling based on the temperature inside the storage area.

In some embodiments, after step 250, the system may continue to monitor the temperature in the storage area. In some embodiments, the system may notify one or more of the assigned drivers and loading dock workers of the time that the target temperature is reached and/or is expected to be reached. In some embodiments, after step 250, the system may further record the actual cooling duration that the target temperature takes to be reached in the storage area. The measured cooling duration may be used to adjust the cooling model used to estimate cooling durations in step 230. For example, if the target temperature is reached prior to the estimated time, the cooling model(s) associated with the conditions (e.g. temperature inside the refrigeration unit, environmental temperature, humidity level, refrigeration unit type, refrigeration unit size, refrigeration unit age, vehicle type, idle time, etc.) of the refrigeration unit may be adjusted to reduce the expected cooling time under similar and/or related conditions.

In some embodiments, after the target temperature is reached, the system may detect for vehicle and/or driver activity. If the vehicle is not turned on and/or if the driver is not present for a set period of time (e.g. 10 minutes) after the target temperature is reached, the system may suspend/stop the cooling of the refrigerated unit. In some embodiments, when the presence of the driver is detected, the system may continue to run the refrigeration unit after the set period of time has passed to allow the driver some additional time for other preparation related tasks. In some embodiments, the presence of the driver may be detected via one or more of the vehicle's door sensor, seat pressure sensors, key sensor, remote control sensor, seat belt connectivity sensor, and the like. In some embodiments, the presence of the driver may be detected by a geolocation sensor and/or a short range transceiver on a portable device carried by the driver and/or by the driver interacting with a portable and/or on-vehicle user interface device. In some embodiments, a driver may be permitted to override the control of the refrigeration unit and manually control the cooling of the refrigeration unit via a local or remote user interface device.

In some embodiments, the system may further detect for the completion of a delivery and automatically turn off the refrigeration unit at or near the completion of a delivery. In some embodiments, the system may determine that the delivery is complete when all items assigned to the refrigeration unit have been scanned as being delivered. In some embodiments, the system may track the location of the delivery vehicle and determine that the delivery run is complete when the delivery vehicle arrives and/or leaves the last delivery stop for the items in the refrigeration unit.

In some embodiments, a delivery vehicle may comprise a plurality of refrigeration units and/or refrigeration compartments. In some embodiments, the target temperatures for each refrigeration units and/or refrigeration compartments may be set to a different temperature. In some embodiments, the estimated cooling duration and the start time may be separately determined for each refrigeration units and/or refrigeration compartments. In some embodiments, the system may cause each refrigeration unit and/or refrigeration compartment on a delivery vehicle to start and/or stop cooling at different times.

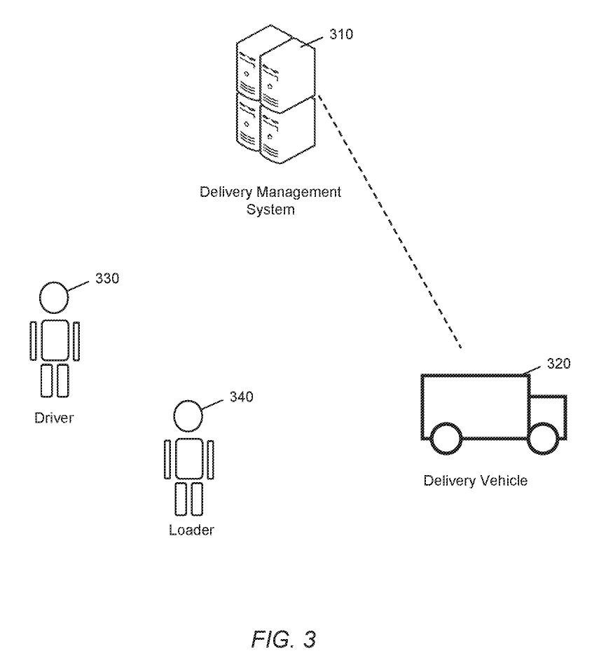

Next referring to FIG. 3, an illustration of a system with refrigeration unit control is shown. The system includes a delivery vehicle 320 and a delivery management system 310. The delivery management system 310 may determine and/or retrieve a delivery schedule for the delivery vehicle 320. The delivery management system 310 may then determine a current temperature and determine a time that the refrigeration unit on the delivery vehicle should begin cooling. Generally, the delivery management system 310 may be configured to cause the refrigeration unit on the delivery vehicle 320 to reach a target temperature just before one or more loaders 340 are scheduled to begin loading the delivery vehicle and/or just before the vehicle is scheduled to depart. In some embodiments, when the target temperature is reached, the delivery management system may send a message to the loader to begin loading the delivery vehicle and/or send a message to the driver 330 indicating that the vehicle is being prepared and/or is prepared to depart. If one or more of the loader 340 and the driver 330 is behind schedule, the system may adjust the expected departure time and suspend and/or delay the cooling of the refrigeration unit. In some embodiments, the driver 330 and/or the loader 340 may use a sensor on the vehicles and/or a user interface device to perform a manual override of the suspension of cooling and/or manually start cooling prior to the start time determined by the delivery management system. In some embodiments, the delivery vehicle may be self driven and/or the loaders may comprise automatous mobile units. In such cases, the system may instruct the automatous mobile units to begin loading the vehicle and/or trigger the departure of the self-driving vehicle based on the time that the target temperature is reached.

Generally, the refrigeration units on a delivery vehicle may be controlled by a central system based on delivery schedules prior to the arrival of a driver such that an associate and/or a driver does not need to arrive at the delivery vehicle early to manually start the refrigeration unit. The system may further use cooling models to reduce the amount of time that the refrigeration unit is running to improve energy efficiency. In some embodiments, the system may use a feedback loop to learn the cooling duration requirements under various conditions such that the idle time between when a target temperature is reached and when the refrigeration unit used is minimized. Generally, utilization of the systems and methods described herein may increase the energy efficiency of refrigerated units on delivery vehicles and reduce the man hours involved in delivery trips.

In some embodiments, the systems and methods described herein may be used to control the temperature of a passenger vehicle. For example, a user may set a departure time for a vehicle and a desired temperature ahead of leaving their home or workplace. In some embodiments, the departure time may be estimated by the system based on a user's past habits. For example, the system may detect that the user always leaves home for work at 7:30 am on weekdays and be configured to prepare the vehicle for 7:30 am departures. The system may then determine a start time for the climate control system of the vehicle based on the current temperature such that the desired temperature is reached at the departure time. The start time may be determined by first determining an estimated temperature control duration for bringing a temperature inside vehicle to a target temperature based on at least the current temperature. The system may then calculate a start time for the climate control unit based on the estimated temperature control duration and the expected departure time. The system may then cause the temperature control unit of the vehicle to start effecting a temperature of the vehicle at the start time. In some embodiments, climate control unit of a vehicle may comprise cooling air conditioning unit and/or a heating unit. In some embodiments, the system may further be configured to turn on heating and/or cooling elements of vehicles seats, steering wheel, wheel shields, and/or car doors similarly.

In one embodiment, a system for refrigeration unit control comprises: a refrigeration unit of a delivery vehicle configured to hold items for delivery, and a control circuit communicatively coupled to the refrigeration unit and configured to: receive an expected load time from a delivery management system, determine a current temperature, determine an estimated cooling duration for bringing a temperature inside the refrigeration unit to a target temperature based on at least the current temperature, calculate a start time for the refrigeration unit based on the estimated cooling duration and the expected load time, and cause the refrigeration unit to begin cooling at the start time.

In one embodiment, a method or refrigeration unit control comprises: receiving an expected load time associated with a refrigeration unit of a delivery vehicle from a delivery management system, determining a current temperature, determining an estimated cooling duration for bringing a temperature inside the refrigeration unit to a target temperature based on at least the current temperature, calculating a start time for the refrigeration unit based on the estimated cooling duration and the expected load time, and causing the refrigeration unit to begin cooling at the start time.

In one embodiment, a system for refrigeration unit control comprising: a refrigeration unit of a delivery vehicle configured to hold items for delivery, a temperature sensor, a wireless communication device, and a control circuit communicatively coupled to the refrigeration unit, the temperature sensor, and the wireless communication device, the control circuit being configured to: receive an expected load time from a delivery management system via the wireless communication device, measure a current temperature via the temperature sensor, determine an estimated cooling duration for bringing a temperature inside the refrigeration unit to a target temperature based on at least the current temperature, calculate a start time for the refrigeration unit based on the estimated cooling duration and the expected load time, and cause the refrigeration unit to begin cooling at the start time.

In some embodiments, a system for vehicle climate control comprises a vehicle comprising a climate control unit, a communication device, and a control circuit coupled to the climate control unit and the communication device. The control circuit being configured to receive an expected departure time from a user device, determine a current temperature, determine an estimated temperature control duration for bringing a temperature inside vehicle to a target temperature based on at least the current temperature, calculate a start time for the climate control unit based on the estimated temperature control duration and the expected departure time, and cause the temperature control unit to start effecting a temperature of the vehicle at the start time.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for refrigeration unit control comprising:
a refrigeration unit of a delivery vehicle configured to hold items for transport; and
a control circuit communicatively coupled to the refrigeration unit and configured to:
receive an expected load time from a delivery management system;
determine a current temperature;
determine an estimated cooling duration for bringing a temperature inside the refrigeration unit to a target temperature based on at least the current temperature;
calculate a start time for the refrigeration unit based on the estimated cooling duration and the expected load time; and
cause the refrigeration unit to begin cooling at the start time.

2. The system of claim 1, further comprising a temperature sensor configured to measure the temperature inside the refrigeration unit, wherein the current temperature corresponds to a current temperature inside the refrigeration unit measured by the temperature sensor.

3. The system of claim 1, wherein the current temperature corresponds to a current environmental temperature.

4. The system of claim 1, wherein the refrigeration unit of the delivery vehicle comprises a refrigerated delivery truck or a refrigerated delivery van.

5. The system of claim 1, wherein the estimated cooling duration is determined based on a cooling model corresponding a plurality of conditions to a plurality of cooling durations.

6. The system of claim 5, wherein the plurality of conditions comprise conditions relating to one or more of: a temperature inside the refrigeration unit, an environmental temperature, a refrigeration unit type, a refrigeration unit size, and a vehicle type.

7. The system of claim 5, wherein the control circuit is further configured to:
determine a measured cooling duration for the target temperature to be reached inside the refrigeration unit; and
update the cooling model based on the measured cooling duration.

8. The system of claim 1, further comprising a second refrigeration unit on the delivery vehicle, wherein the control circuit is configured calculate a second start time for the second refrigeration unit.

9. The system of claim 1, wherein the start time is calculated based on reaching the target temperature shortly before the expected load time.

10. The system of claim 1, wherein the control circuit is further configured to:
detect a completion of a delivery; and
automatically turn off the refrigeration unit at the completion of the delivery.

11. The system of claim 1, wherein the control circuit is further configured to automatically cause the refrigeration unit to begin cooling prior to an arrival of a driver of the delivery vehicle.

12. The system of claim 1, wherein the control circuit is further configured to accept manual override to begin and stop the cooling of the refrigeration unit.

13. A method or refrigeration unit control comprising:
receiving an expected load time associated with a refrigeration unit of a delivery vehicle from a delivery management system;
determining a current temperature;
determining an estimated cooling duration for bringing a temperature inside the refrigeration unit to a target temperature based on at least the current temperature;
calculating a start time for the refrigeration unit based on the estimated cooling duration and the expected load time; and
causing the refrigeration unit to begin cooling at the start time.

14. The method of claim 13, wherein the current temperature corresponds to a current temperature inside the refrigeration unit.

15. The method of claim 13, wherein the current temperature corresponds to a current environmental temperature.

16. The method of claim 13, wherein the refrigeration unit of the delivery vehicle comprises a refrigerated delivery truck or a refrigerated delivery van.

17. The method of claim 13, wherein the estimated cooling duration is determined based on a cooling model corresponding a plurality of conditions to a plurality of cooling durations.

18. The method of claim 17, wherein the plurality of conditions comprise conditions relating to one or more of: a temperature inside the refrigeration unit, an environmental temperature, a refrigeration unit type, a refrigeration unit size, and a vehicle type.

19. The method of claim 17, further comprising:
determining a measured cooling duration for the target temperature to be reached inside the refrigeration unit; and
updating the cooling model based on the measured cooling duration.

20. The method of claim 13, further comprising:
calculating a second start time for a second refrigeration unit on the delivery vehicle.

21. The method of claim 13, wherein the start time is calculated based on reaching the target temperature shortly before the expected load time.

22. The method of claim 13, further comprising:
detecting a completion of a delivery; and
automatically turning off the refrigeration unit at the completion of the delivery.

23. The method of claim 13, further comprising: automatically causing the refrigeration unit to begin cooling prior to an arrival of a driver of the delivery vehicle.

24. The method of claim 13, further comprising: accepting manual override to begin and stop the cooling of the refrigeration unit.

25. A system for refrigeration unit control comprising:
a refrigeration unit of a delivery vehicle configured to hold items for delivery;
a temperature sensor;
a wireless communication device; and
a control circuit communicatively coupled to the refrigeration unit, the temperature sensor, and the wireless communication device, the control circuit being configured to:
receive an expected load time from a delivery management system via the wireless communication device;
measure a current temperature via the temperature sensor;
determine an estimated cooling duration for bringing a temperature inside the refrigeration unit to a target temperature based on at least the current temperature;
calculate a start time for the refrigeration unit based on the estimated cooling duration and the expected load time; and
cause the refrigeration unit to begin cooling at the start time.

26. A system for vehicle climate control comprising:
a vehicle comprising:
a climate control unit;
a communication device; and
a control circuit coupled to the climate control unit and the communication device, the control circuit being configured to:
receive an expected departure time from a user device;
determine a current temperature;
determine an estimated temperature control duration for bringing a temperature inside vehicle to a target temperature based on at least the current temperature;
calculate a start time for the climate control unit based on the estimated temperature control duration and the expected departure time; and
cause the temperature control unit to start effecting a temperature of the vehicle at the start time.
